(19) United States
(12) Patent Application Publication
(10) Pub. No.: US 2015/0334080 A1
(43) Pub. Date: Nov. 19, 2015

(54) SYSTEMS AND METHODS FOR A KEYWORD/KEY PHRASE URL AND PATH REPLACEMENT AND MANAGEMENT

(71) Applicant: Reinaldo Tamayo, Miami, FL (US)

(72) Inventor: Reinaldo Tamayo, Miami, FL (US)

(21) Appl. No.: 14/707,135

(22) Filed: May 8, 2015

Related U.S. Application Data
(60) Provisional application No. 61/996,726, filed on May 15, 2014.

(51) Int. Cl. H04L 29/12; G06F 3/048; H04L 29/08

(52) U.S. Cl. CPC H04L 61/10; H04L 61/1511; H04L 67/02; H04L 67/10; G06F 3/048

(57) ABSTRACT

In accordance with one embodiment, a server portal replacing and representing URLs, paths, macros, and other methods with simple easy to remember and input keyword(s) with or without the use of special symbols or combination of special symbols and or letter (commonly known as hashtags). The server portal provides an enhanced user experience for users to reach often long and complex URLs by just having to remember an easy keyword or keyword phrase that they encounter in business cards, TV, radio, publications, brochures, sky writing, or any other media type without limitations. The server portal is used by means of a browser, software, app, search tool, operating system, messaging systems, or other smart devices to query the keyword server and retrieve the URLs or paths when the keyword is inputted obviating the need to remember the URL and allowing great ability for anyone to provide targeted customizable measurable content to the user in a simple and easy to use manner instead of using long and complicated URLs, paths, etc. and also use it to facilitate voice input and search. Additionally this novel invention allows for other services and methods beyond advertising and URL replacement which are not possible to achieve without it.

This application claims priority to U.S. provisional patent application No. 61/996,726 filed May 15, 2014, which is incorporated herein by reference.

### BACKGROUND OF THE INVENTION

1. Field of the Invention

Embodiments of the present invention generally relate to any device or method that leads to a Uniform (or Universal) Resource Location (URL hereinafter) on the internet (hereinafter all known simply as “net”) or any network (hereinafter internet will mean the actual internet as well as any network, private, semi-private, or public which uses URLs or other paths to send users to a specific resource or provide users with information among other uses) or device such as a computer, network, wearable computer, smart phones, or a myriad of other smart device that can deliver the user to paths inside itself or even URL produced by the user himself or herself or gathered from the keyword server over the internet or network. The invention involves a novel method of using keywords rather than domains and URLs to send the user to a specific page or path when the keyword is inputted in the address bar of any browser, a third party browser plug-in or extension, a search box in any site, a search box in any software or OS, a saved macro that can be ran from a search box, text message, or anywhere in any OS and is particularly useful for voice commands on mobile devices but it is also useful in other devices, a path box, embedded in text and other kinds of messages, among other methods. Keywords can also be keyword phrases (hereinafter keyword will mean both a single keyword and a keyword phrase of any length even if its plural form is not used) and can be used alone or with tags such as hash tags (hereinafter hashed and hash tag and tag and special character is meant to be more than the hashtag character itself, it can mean any special symbol or combination of symbols and words) and other special symbols (hereinafter special symbol means also any combination of special symbols and/or letters) or combination of letters and symbols being used at the beginning and/or end of the keyword. The special characters or combination of letters and symbols can be used to designate the keyword when using it in content such as but not limited to TV, radio, business cards, brochures, window display, printed materials, display advertisement of any kind, and many more; but it is not required to make the system work and can be found without the special character, though using it clarifies the search for the search mechanism. Although not necessary the use of specific symbols licensed to given companies for their exclusive use can also allow them to sell keywords and allow for greater chances of a user being able to own a specific keyword because it allows for multiple version of the keywords to be available when accompanied by the various hashtags.

This embodiment of the present invention can be used in many ways and for many different purposes. Though the focus of some of the systems and methods being described here is for online advertisement and online path redirection, it has many other applications and the focus should not limit its other possibilities. With this system pesky long URLs can be linked to relatively short and easy to remember natural language words with or without a hashtag associated with it. Other methods that have been tried are using QR code or shorten URLs but these have a problem that they are either not easy to remember or require a cell phone or some other device that can read the QR code and usually work only on permanent media such as print media, they are not very useful for usage in a fluid media such as TV. With this system anyone can easily remember the keywords and type them on the search engines or URL of the browsers and find the keyword there and be redirected to the correct URL. Not only is it more practical and easy to remember but it is easy to use especially in mobile devices and other devices in which typing is difficult and since it uses natural language can even take the input in the URL bar through voice input, gestures or other input methods. This system does not replace the existing URL and internet addressing method, it only makes it easier to use it.

2. Description of the Related Art

The use of mobile devices in particular has required an easy way to input very long URLs since it is still difficult to input URLs in a mobile device due to the device constraints. Quick Response Code (QR or QR Code hereinafter) is being used to help with this but not everyone knows about them, knows how to use them, and/or have the QR code apps to read them, and they are still impractical for certain media such as television and radio among others. The same problem exists when using television, print, radio, business cards, and other types of advertisements where URLs are simply impractical for the most part as even short URLs are hard to remember and still relatively long. With the advent of Twitter many companies have started advertising the relatively short and much easier to remember Twitter ID or Twitter hashtags so that the public has some easy connection to them; but this is still impractical because not everyone uses Twitter and the information that is given in twitter is quite limited and ephemeral in nature; and worse yet it does not lead to a property under their control and one which they could be banned or lose. Search engines are a great source for finding information but not as effective for targeting information and they do not help with off-internet advertising or promotions and using them to find information, especially URLs, user saw in another media is quite difficult.

The need to provide potential customers or contacts with a unique traceable URL is still quite high as companies are using much more sophisticated methods of measuring traffic and personalizing the user experience. Gone are the days that everyone landed in the home page, or that a home page looks the same for everyone; almost all pages are now customized for each individual or group of individuals based on many factors. The need to have relatively long URLs to track and personalize user experience is greater as time passes. Having a method of simplifying URL entry by replacing them with an easy to remember keyword is paramount for continued improvements in personalization and traffic tracking.

Despite best efforts to date, it is clear that the current methods of attempting to do this fall short in many ways as explained above. There is currently no elegant and effective easy to use method of allowing users to reach a URL from outside the internet itself. URLs, even relatively short ones are just too cumbersome and in order to track and personalize the landing page (hereinafter landing page refers to the destination page where the URL resolves) they have to necessarily become quite long. Typing URLs in text message in cell phones and other chat communications is also quite hard and with the cooperation of the operating systems and apps or software designed for this purpose the hashtags can be used to simplify that issues as well; among solving several other issues.

Now the internet has advanced enough to be able to allow keywords to be used to replace URLs particularly for use in other media. The URL is not replaced only tied to the keyword so when the keyword is typed into the browser URL box, the browser or a browser plugin, a search box, or other input mechanism, can recognize it when checking with a keyword server that has the keyword registered and resolve the keyword into the associated URL and send the user to the correct highly targeted and customized landing page as the resolving URL can be of quite long and carry significant tracking information. If used with licensed special characters, then multiple types of the same keywords can be available and sold changed only by the special character.

Since most of the net is reached with the use of internet browsers, the key to the success of this keyword system is to have the browsers incorporate the code to access the keyword server when someone is doing a search or inputting a URL so the auto-complete URL and search results will also include the keywords suggestions. Obviously if a user knows the keyword and is inputting to go directly the autocomplete does not really matter but they might reach it faster since it will show in the list before they will finish the input. Either way the simple easy to remember keywords can be used to reach a complex URL. If the browser does not add the code a simple browser plugin can be used to achieve the same function. The same can be done in a search engine or search function.

The URL system is very effective but it is antiquated compared to the fast paced modern life and while it may still function for decades to come it can still be improved and simplified when used in parallel with keywords tied to the URL. Presently there is increasing new media sectors being created but they all eventually land in a URL, even mobile apps still use URLs, so the URL is here to stay and simplifying it is paramount. No current method of simplifying the way the URL works is very effective, a new method is needed to simply the process.

### SUMMARY

In accordance with one embodiment, a method for reaching a URL using a replacement keyword tied to the URL but easier to input and remember, with or without special symbols, and its management is provided. The server portal provides a completely unique and enhanced means of reaching even complex URLs with a single keyword or keyword phrases of various lengths, with or without special symbols. The method for a server portal for a URL keyword manager may include a user interface enabling the user to interact with the method including being coded directly into a browser and/or a plugin or into a network, computer, or smart device such as a smart phone or wearable computer device, and/or device Operating Systems (OS hereinafter) which uses paths or some other relatively lengthy and difficult to input mechanism. In one embodiment of the subject matter disclosed herein, the portal may be accessible using a mobile device or any means of accessing the internet or any media that uses URLs, paths, or other lengthy addressing mechanisms. It can also be used with systems that use paths such as but not limited to for example saving a keyword that leads to specific saved paths inside a computer or network system to expedite reaching specific content and inside text communications.

In one embodiment, the portal may be configured to work only from a third party browser plugin or any software and/or OS (hereinafter when mentioning software, it will include OS as well). The plugin or software can be installed in a browse or server as a software intermediary or directly as part of the OS. The software can also be installed in many places in a network system or single computer or smart devices such as mobile devices and wearable computers to reach internal locations in a network or computer or smart device but they all work the same no matter where they are located except in a network or individual PC or other smart devices the database that correlates the keyword to the path or URL is usually but not necessarily always located in the network server or computer or smart device itself.

In yet another embodiment, the method includes a business module for facilitating the purchase and/or management of the keywords in the keyword server and if needed deal with several forms of the same keyword using licensed special symbols which may be sold to third party companies to extend ownership of the same keywords to more than one entity. The business module can function in many ways but its primary purpose will be to sell, auction, add, edit, delete keyword and once a keyword is found on the internet, network, or device to send the user to the correct URL or path. In one embodiment it serves as the management of the keywords by adding, deleting, editing, trading, accepting payment, keeping track of clicks and keeping accounting of monies owed, keeping track of refunds and many other business functions related to the purchase, payment, and management of keywords. Other related embodiment takes care of serving the keywords once inputted to the user through the various ways in which the keywords are inputted. Yet another related embodiment allows for third parties selling the keywords and for browsers and other parties involved in the process including those selling keywords to receive payment and commissions for their participation. In yet another related embodiment the server will also present a website where any user can search and pay for keywords and manage the keywords themselves while also allowing third party managers to manage keywords for their owners. There are many other possible embodiments of the keyword management server and the functions and embodiment herein described may actually be managed in more than one server or location and server is used here as a mean to explain that there will be some managing entity controlling all functions of this keyword sales and management system.

As a further embodiment and explanation of the method, the keyword vs. URL or path is needed because it allows for better advertisement, promotion, public relations or simply someone trying to be found easier from all media types and gives people the ability to more easily remember a way to get in touch with the entity using it. The person would find the keyword in any or all but not limited to these examples, business cars, TV, radio, mobile devices, ads, articles, mobile text messages, sky writing, or literally any medium possible. When the person sees or is exposed to the keyword and goes to input it in a browser, software, or other location (hereinafter browser for clarification purposes), the browser offers possible keywords as the person types and when they finish typing and click enter or when they click on a suggested keyword, the person is take to the URL or path and the interaction is recorded. If for whatever reason the keyword is not found or when inputting, related keywords which are unsold, may appear to allow users to purchase them. Once the keyword takes the person to the URL or path the interaction ends although the person may be cookied or in some way continue to be tracked for tracking purposes if they allow it in which case the keyword server may continue collecting data on the interaction. Keywords can be inputted with or without a hash tag of some kind in front and/or behind it or without such a hash tag but for a psychological purpose for the sake of indicating the keyword is a keyword the owner can choose a hash tag to use before and/or after the keyword so that people can note that this is a keyword. This is purely at their option as it is not necessary unless special symbols are licensed and used globally in which case the special hashed keywords will be required except that it does not need to be hash tag it can be any special symbol or combination of letters and/or symbols and the keyword can still be found without it, the user will just need to choose the right one from the several other versions with different special symbols.

### BRIEF DESCRIPTION OF THE DRAWINGS

The drawings, in which like numerals represent similar parts, illustrate generally, by way of example, but not by way of limitation, various embodiments discussed in the present document.

FIG. 1 illustrates a flowchart of the functional way in which a keyword is used in a browser although it could easily be used in any search box or in another software or location in a computer or smart device.

FIG. 2 is a flowchart illustrating the keyword server function for resolving keyword URLs and accepting new purchases and management of keywords.

FIG. 3 is a flowchart illustrating one of many possible purchasing and bidding mechanisms possible for the sales, renewal, and payment of the keywords. It is used only as an example of many possible financial vehicles that can be used to charge for keywords.

FIG. 4 is a flowchart illustrating the user interface and how it works when using a keyword in various ways and situations.

FIG. 5 is a flowchart illustrating how keywords are used in a network server, computer, or other smart devices to reach a path usually, although it can also reach URLs.

FIG. 6 is a flowchart illustrating how special symbols or combinations of special symbols and/or letter can be used to enhance the ability for more than one user to own a keyword when licensed to third party companies or used simply without licensing.

### DETAILED DESCRIPTION

The foregoing summary, as well as the following detailed description of certain embodiments of the subject matter set forth herein, will be better understood when read in conjunction with the appended drawings. As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

To the extent that the term “includes” is used in either the detailed description or the claims, such term is intended to be inclusive in a manner similar to the term “comprising” as “comprising” is interpreted when employed as a transitional word in a claim. Furthermore, the term “or” as used in either the detailed description or the claims is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B.

In the following detailed description, reference is made to the accompanying drawings which form a part hereof, and in which are shown by way of illustration specific embodiments in which the subject matter disclosed herein may be practiced. These embodiments, which are also referred to herein as “examples,” are described in sufficient detail to enable those skilled in the art to practice the subject matter disclosed herein. It is to be understood that the embodiments may be combined or that other embodiments may be utilized, and that structural, logical, and electrical variations may be made without departing from the scope of the subject matter disclosed herein. The following detailed description is, therefore, not to be taken in a limiting sense, and the scope of the subject matter disclosed herein is defined by the appended claims and their equivalents. In the description that follows, like numerals or reference designators will be used to refer to like parts or elements throughout. In this document, the terms “a” or “an” are used, as is common in patent documents, to include one or more than one. In this document, the term “or” is used to refer to a nonexclusive or, unless otherwise indicated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

It is to be understood that the embodiments and features that are described herein may be implemented by hardware, software, firmware or any combination thereof. Various embodiments described herein are described in the general context of methods or processes, which may be implemented in one embodiment by a computer program product, embodied in a computer-readable medium, including computer-executable instructions, such as program code, executed by computers in networked environments.

The various embodiments and/or components, for example, the modules, elements, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as an optical disk drive, solid state disk drive (e.g., flash RAM), the remote storage option commonly known as “the cloud” or “cloud computing” and the like. The storage device may also be other similar means for loading computer programs or other instructions into the computer or processor or remote virtual or physical processes.

As used herein, the term “computer” or “module” may include any processor-based or microprocessor-based system including systems using microcontrollers, reduced instruction set computers (RISC), application specific integrated circuits (ASICs), field-programmable gate arrays (FPGAs), graphical processing units (GPUs), logic circuits, cloud computing and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments of the invention. The set of instructions may be in the form of a software program, which may form part of a tangible non-transitory computer readable medium or media. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, the terms “software”, “firmware” and “algorithm” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

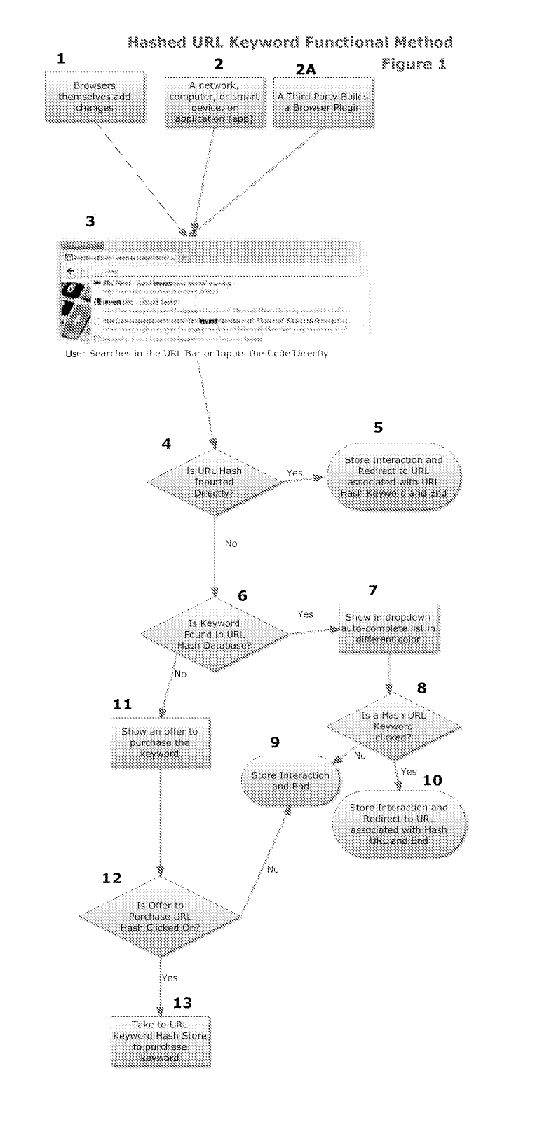

FIG. 1 illustrates a flowchart of the general way in which the URL Keyword manager works when the keyword is being used at a browser but the process is the same for finding Paths in other locations other than a browser or browser plugin such as from the navigation bar in any computer, search box of any kind, smart device, or wearable computer, or application (hereinafter app) in a smart device; in which case both a Path and a URL can be obtained. Since all methods work on the same principle only the browser is illustrated here but it represents all other methods as well.

Block 1 shows how the keyword manager for inputting keywords can be installed directly into a browser by the browser company.

Block 2 shows how the keyword manager for inputting keywords can be installed directly in a network, computer, or smart device such as a mobile phone or wearable computer or app in a smart device.

Block 2A shows how the keyword manager for inputting keywords can be installed in a browser plugin or extension.

Block 3 shows a representation of a typical browser where something is being inputted into the address bar and the browser is offering auto-complete suggestions. This shows a facsimile of what inputting the keyword into a browser or other such type of input method might look like and show that paid keywords are shown as suggestions if the keyword input has not been completed, as well how unsold keywords related to that keyword can also be shown to be purchased. The mechanism is very similar in networks, computers, and smart devices and apps.

Block 4 shows a decision as to whether the keyword is fully inputted or is still being searched for at the input box.

Block 5 shows that when a keyword has been inputted and valid it can take the person directly to the URL and the server will record the interaction which will be used in many ways including for statistical reason. If the person allows tracking a cookie or some other tracking mechanism will be utilized to track the transaction.

Block 6 shows a query that decides whether a keyword has been found in the keyword server or not.

Block 7 shows how even when a partial keyword is found the system shows it in the drop-down auto-complete as a choice in a different color to distinguish it from the other search results.

Block 8 shows a query as to whether the keyword has been completed or clicked on.

Block 9 show that if the keyword is not found, completely inputted, or clicked on from the choices shown, the system stores the interaction and ends.

Block 10 shows that if the keyword is found, completely inputted, or clicked on the interaction is recorded and the person is forwarded to the associated URL or path associated with the keyword. If they allow tracking they may receive a mechanism for continued tracking. After storing the interaction the system ends unless it continues tracking.

Block 11 shows how when a keyword is not yet acted on; a related keyword can still be clicked on for purchasing that related non-owned keyword. Although this is a convenience for the person, there are other various ways to purchase and managing the keywords, including but not limited to purchasing and managing from the keyword managing company itself, from resellers, from the browser company, etc.

Block 12 shows a decision to see if a related keyword that was presented for purchase was clicked on. If not clicked on the interaction is recorded and the system ends.

Block 13 shows if a competing keyword is clicked on for purchasing it gets directed to the appropriate selling agent or the keyword managing company.

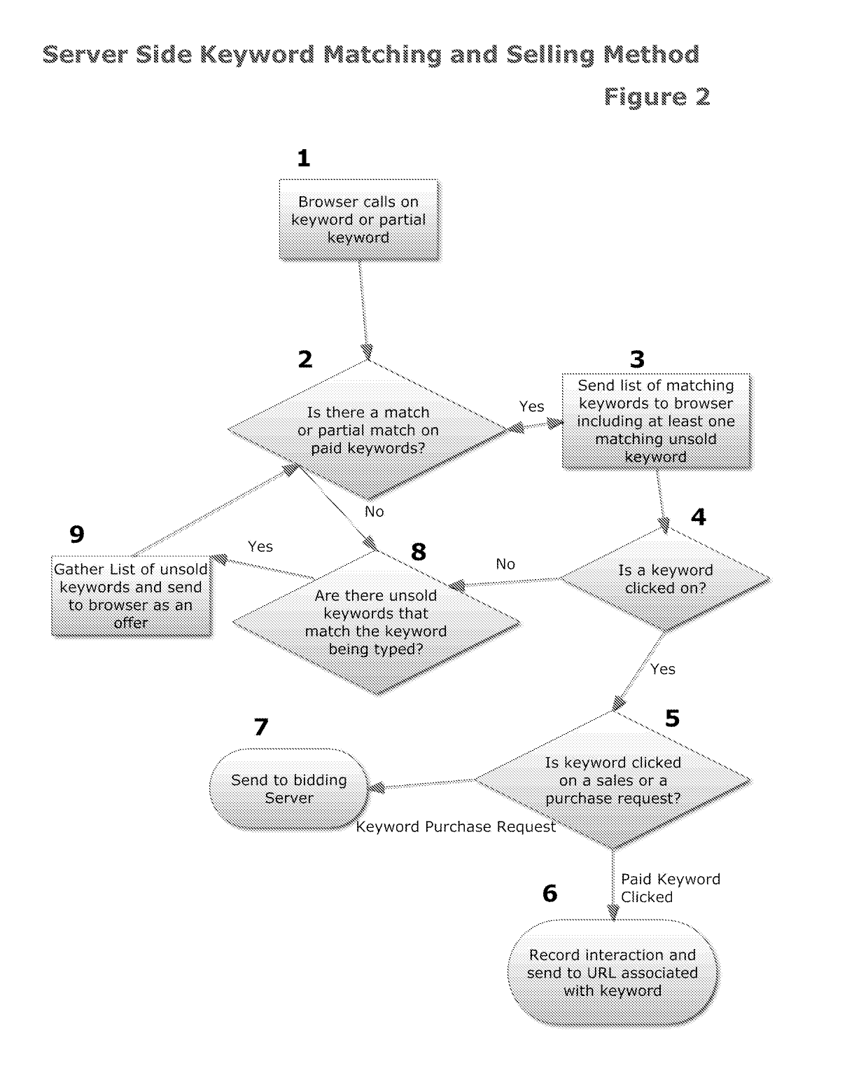

FIG. 2 is a flowchart illustrating server side keyword matching and selling method accordance with an embodiment. On the keyword server many functions happen but they are primarily broken down to two major functions: serving keywords that are owned already and proposing similar keywords and keyword phrases which are not yet owned or are being leased so they can be purchased. The purchasing method, the third major function, is described in a separate figure.

Block 1 shows the browser or software being used makes a call on the keyword server to match a partial keyword and offer suggestions to the user of potential keywords and potential keywords that can be purchased or leased from the partial keyword being typed letter by letter until the typing is complete. This works identical as the system currently work when typing something in the address bar of a browser as it gives suggestions of search terms and URLs, in this case it would add keyword suggestions as well.

Block 2 shows a query as to whether the partial keyword matches any paid keywords. Please note the unpaid keyword search is stronger in the second path but even if paid keywords are found there will be at least one unpaid related keyword that will be sent when returning keywords to the browser. Each letter typed returns a different more complete and accurate list of keywords.

Block 3 shows that if there are matching keywords/keywords fragments the server will return a list of the matching keywords and at least one unsold related keyword. This process gets repeated over and over again while the keyword is being typed until an action happens, this is why there is two headed arrow to indicate the back and forth of this process.

Block 4 shows a query to check if the keyword has been clicked on in the browser.

Block 5 shows another query that happens if the keyword was indeed clicked on. It checks if the clicked keyword was a paid keyword to see if it needs to send the user to the URL associated with it or if it was an unpaid keyword to send them to the paying process.

Block 6 shows that when a paid keyword is clicked the interaction is recorded and the person is sent to the resulting URL of the paid keyword and the process ends unless there a tracking capability allowed in which case that capability continues.

Block 7 shows that if the keyword clicked on was a keyword for sales it takes the person to the server for dealing with paying for the keyword. A possible, of many possible mechanisms, for paying for the keyword is shown in a different figure.

Block 8 shows a query that checks if there are unsold keywords that can be sent to the server. While there will always be at least one unsold keyword sent to the server with each query, if there are no sold keywords there will be many more unsold keywords sent and this is the part of the method that handles these decisions. In the case of this working inside a computer, network, or other device or app for sending to paths alone there may not be selling of keywords at that point and so this portion of the method may not exist in it, however as the software can also serve paid and unpaid keywords the user may need to decide if they want to have these keywords included in the return as well.

Block 9 shows how the gathered list of unsold keywords are sent to the browser or software to be served.

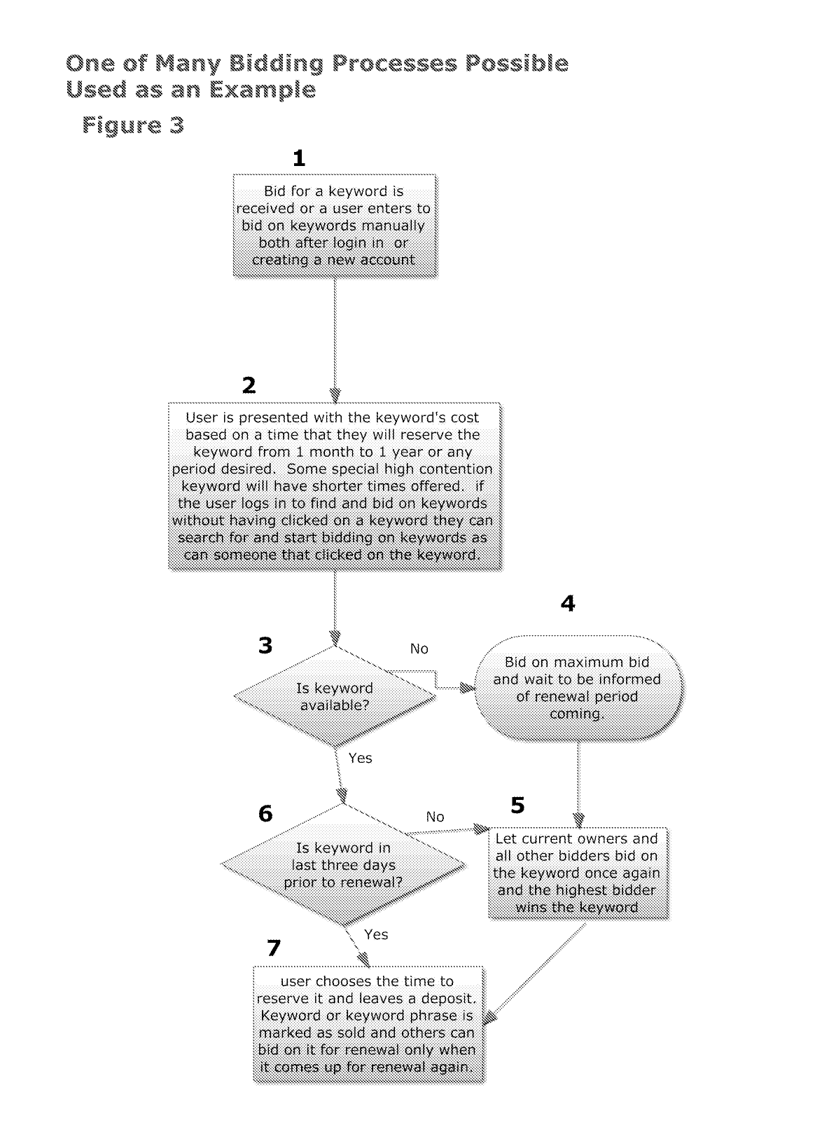

FIG. 3 is a flowchart illustrating one of many possible payment methods for the keywords with an embodiment. This payment method relies on a bidding system that allows others to challenge for ownership of the keyword if they are willing to pay more for it when it comes to renewal. Another of many possible methods is simply to tie the cost of the keyword to the cost of the adwords in the browser system selling the keyword or an adword bidding system inside the keyword server that keeps the prices of the keywords moving and increasing or decreasing based on usage and bids for adwords. Another of many possible methods is to have the current owner ask for a bid from others that want the keyword and have an auction for the sales of the keyword to them. The initial keyword cost prior to having an owner can possibly, knowing there are many other methods, be based on the current adword cost in Google and/or Bing whichever is higher with a premium added for the permanency of owning the keyword which may also include a flat monthly fee. While these payment methods may be tied to adwords they are done for convenience only, they have nothing related to adwords nor do they work like adwords do, they only use adwords as a firm method of establishing the value since that is a proven method for valuing keywords and keyword phrases.

Block 1 shows that a user must login or create a new account in the keyword server to start bidding on a specific keyword which was clicked on from a browser competitive keyword display or the user is coming to find keywords on his or her own and is ready to start bidding or ready to manage keywords. Please note while the Figures herein broach the subject but do not show extensive information on editing and deleting keyword accounts and abandoning keywords, these are all functions that the server will have and are not explained in details as they are standard features of any business application and not novel in design.

Block 2 shows that if a user clicked on an unsold keyword they are presented with the keyword its cost and they can choose the length of time they want to own the keyword for. It also illustrates that if someone logins in to search for and bid on keywords or to edit, abandon, keywords or any other possible action of managing an account they can. As can the person coming in for that keyword they clicked on. It also explains that certain super popular or high value keywords may have reduced period of time of ownership before it needs renewal because bidding on it make the cost keep rising and therefore it needs more frequent renewal.

Block 3 shows a query to see if the keyword is currently available for immediate purchase. The keyword might have been placed as an unsold keyword because it was in the last three days and therefore the renewal period so that bidders can bid on it possibly win it from the current owner and this is why it might not be immediately available but available with a strong bid after three days. Even if there is no renewal period the user can still bid on a keyword and be notified once again when they are outbid or when the renewal period comes up.

Block 4 shows how a person can bid on a keyword that is already owned for a chance to own it if the owner abandons it or does not match the maximum bid. This bidding can be done at any time but it gets specially heated during the last three days of the renewal process.

Block 5 shows if the bidding is in the last three day of the renewal how the current owner and all other bidders can bid to try to get the keyword. They owner just needs to match the highest bid and beat it by 1 cent.

Block 6 shows a query as to whether the keyword is in the last three days of a renewal process or if it has an owner already. If it is in the renewal process then it goes to bidding against everyone that wants it.

Block 7 shows how an unsold keyword gets sold and marked as sold and any subsequent bids on it will be handled at the renewal process. The user now owns that keyword for the period of time they specified.

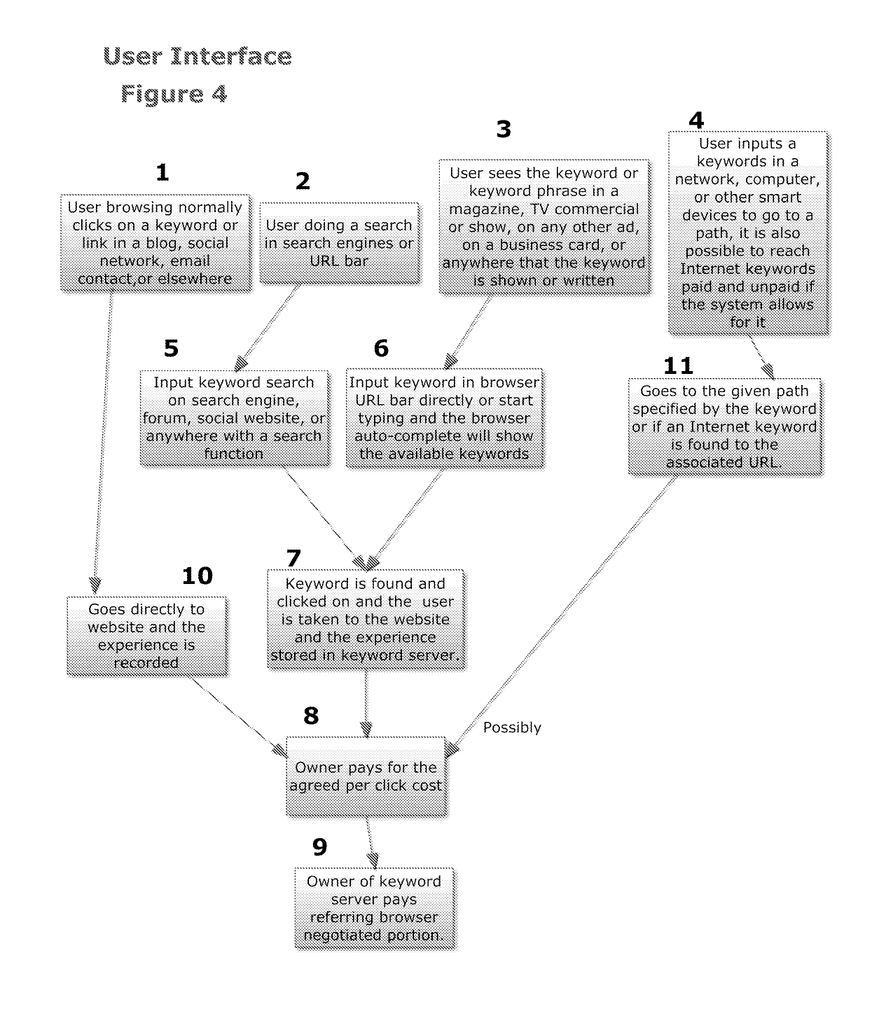

FIG. 4 is a flowchart illustrating the many interfaces possible for the user to accomplish the keyword method with an embodiment. There are many ways to use the keyword and this Figure illustrates several of them though other ways are possible.

Block 1 shows how a keyword can be found in the wild in blogs, social networks, and other places inside content. When clicked the keyword can take the user to the URL associated with it.

Block 2 shows the user can type the keyword in a search engine or address bar of a browser and find the keyword being served there.

Block 3 shows the most common way of encountering the keyword other than in the address bar which is the main purpose of having keywords. They can be found in many off-internet places such as, but not in any way limited to, business cards, magazines, print articles, TV shows, TV commercial, radio shows and commercials, display windows, flyers, and many more. Since the primary purpose for these keywords is for people to remember them when not connected, they will be heavily used in these media, but not limited to them.

Block 4 shows that when using a software in a computer, network, smart device, app, among many other possibilities, that they can be taken to stored paths inside the system. But because these systems can also take to URLs they can also have keywords designed for taking people to URLs and these URLs can be internal to the system or they can also be pulled from the commercial keyword server. This method also allows for easy access through voice commands since the keywords are usually normal words and the voice recognition system can understand them which will make entry specially in difficult to enter systems like mobile phones much easier.

Block 5 shows how an inputted keyword from a search is handled. No matter what search mechanism is used, whether in a search engine, a search system in any page or content, or whatever mechanism is used, the keyword is found and clicked on.

Block 6 shows how a keyword found outside the internet can easily be typed in the browser address box or in search engines and other places to arrive at the keyword to click and go directly to the URL associated with it.

Block 7 shows how when the keyword is clicked on the experience is stored and the person is taken to the associated URL.

Block 8 shows that the owner is immediately charged for the usage.

Block 9 shows how the owner of the keyword server accounts for the referral and credits a commission to the entity referring if any exists. This may or may not exist depending on the arrangements and where the referral came from; for example a referral from a software product inside a computer may not require payment.

Block 10 show how after clicking on a keyword found inside some content is clicked the user is sent directly to the URL and the experience is recorded.

Block 11 shows if the keyword inside a computer, network, smart device or any other such methods it send the user to the path inside the system but it can also handle URLs that are saved by the user in which case there would not be any payment by the keyword owner (if any exists) but it can also check with the keyword server and serve paid keywords and unsold keywords if setup to do so in which case it can take the user to a paid keyword and the appropriate recording of the interaction be made and the step that follow as well.

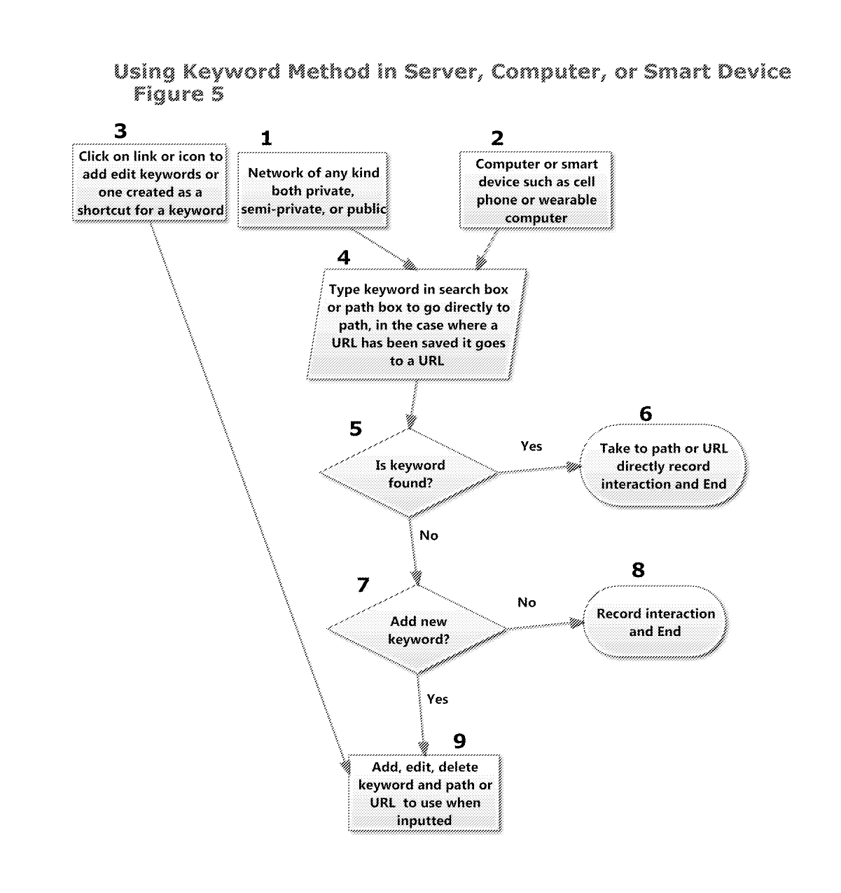

FIG. 5 is a flowchart illustrating how keywords can be used in servers, networks, computer, smart devices, apps, and many other to send users to specific paths inside the system or even URLs both of the kind generated by the user and also in conjunction with the commercial keyword server with an embodiment. The system will usually be a third party app but can also be coded into the OS and apps and is particularly helpful with mobile phone and other hard to input devices and of course it can be voice activated as well as with all of the other methods described in this invention.

Block 1 shows how any network, private, semi-private, or public can be used with the keyword system to reach paths and/or URLs in it.

Block 2 shows how computers, smart devices such as cell phones or wearable computers, apps, among others can be used with this keyword systems for paths and/or URL shortcuts. This is especially useful with mobile phones and wearable computer devices because of the ease it creates in navigating around and reaching URLs; both user created and from the commercial keyword server.

Block 3 shows how editing/deleting of the current keywords or adding new keywords can be reached by clicking an icon or link. But also how a link or icon can be created for commonly used keywords as well.

Block 4 shows how a keyword typed in the OS search box or on any path box can allow a user to go directly to the associated path or URL. But icons and links can also be created for these purposes.

Block 5 shows a query to see if the keyword chosen is found.

Block 6 shows if they keyword is found then it takes the user to the path or URL associated with the keyword.

Block 7 shows if the keyword is not known then it queries as to whether to add it to the keyword list.

Block 8 show how if a keyword is not desire the system records the interaction and ends.

Block 9 show if the new keyword is desired or if an icon or link is pressed to go to the keyword administrator, the administrator can be entered to add, delete, and edit keywords among many other functions.

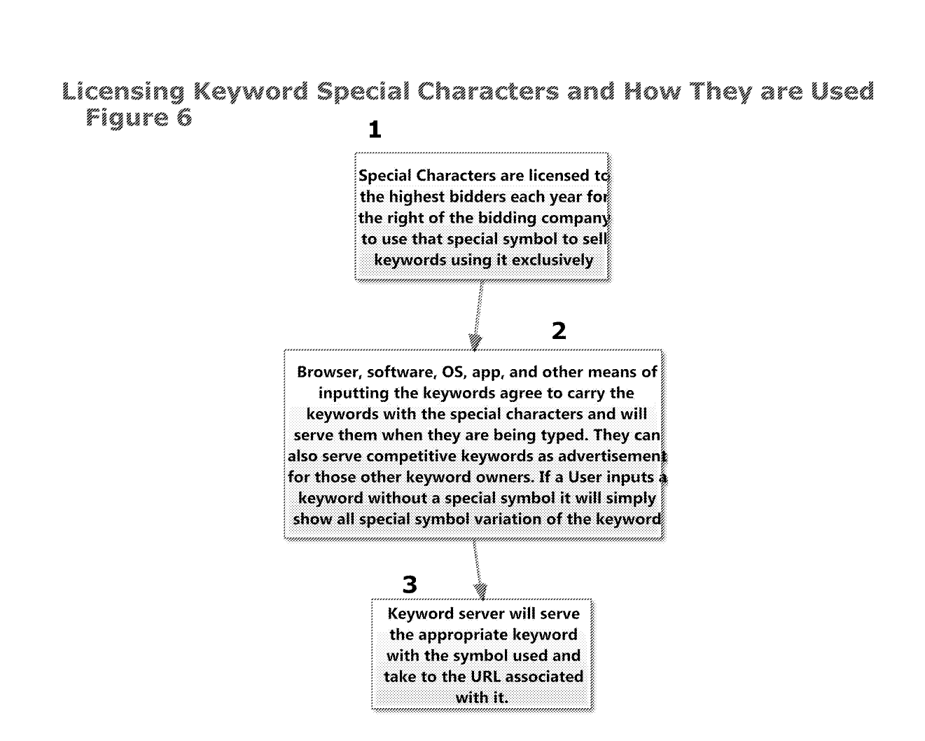

FIG. 6 is a flowchart illustrating how special symbols or combinations of special symbols and/or letter can be used to enhance the ability for more than one user to own a keyword when licensed to third party companies or used simply without licensing.

Block 1 shows how a process for bidding for special characters and character and/or letter combinations (herein after symbols) can exist, though it is not absolutely necessary for this to function, that allows many entities to license the right for certain symbols so they can sell those symbols with the same keywords as a way to allow more users to have access to the same keyword without overwhelming the choices. Symbols are a great way to tell people the keyword is special as is commonly used now in Twitter and Facebook with the @ and # symbols which means they are in common use. The licensor will have exclusive control and rights to those symbols for a set period of time when they license them.

Block 2 shows how the entities providing the means of accessing the keywords can agree to carry the symbols along with the keywords and this is also important to them because if they do they can also charge advertising fees for the other symbols to appear at the same time as a competitive measure. The keywords will still work without the symbols, it is just with the symbol they will be faster to input as without it they will need to choose from the many other potential symbols.

Block 3 shows how the server will identify the correct keyword associated with that symbol and send the user to the right URL while also recording the interaction.

What is claimed is:

1. A novel navigation system that uses natural language and other input methods and seamlessly forwards users to corresponding domains or existing URL protocols. This is possible because browsers and browser plugins and operating systems and mobile and net apps and software with some modification can allow for existing URLs to be replaced by any text or symbol whether or not using hashtags or other symbols; to allow a new form of input using natural language navigation or symbol, gesture, and other types of input to achieve direct navigation without directly using the URL protocol or other existing navigation methods. Inputs do not have to be textual or verbal and can contain many new types of inputs as mentioned including but not limited to gestures, biometrics and without limits other measurement of the body or body functions, non-text symbols, among many other novel and new input methods potentially available now and in the future. Similarly DNS Severs (name servers) and other kind of navigation related servers can be modified to recognize these keywords and symbols and other input methods much as they do domains currently and serve them directly without the aid of other software or mechanisms. This navigation method while it has great commercial application as an advertising method can be used without the advertisement methods equally well since its novel mechanism does not require the advertisement component to work, though it is optimally used as an advertisement tool. As seen in claim three (3) below, unique services can be created from this navigation methods such as, but not limited to, creating unique worldwide universal user identifications. This navigation method is particularly suited to mobile devices, internet of things devices, and other novel new systems which can be used to navigate even without text and it is not limited to just the internet.
The portal further comprises a method of allowing anyone to simplify the way URLs and paths are represented and values replaced by using simple easy to remember and type keywords or spoken using voice command or using visual input or gestures (including familiar gestures also including but not limited to sign language for example) among other ways that are associated with a URL, a path, a macro, etc. no matter their length or complexity into a simple easy to remember keyword or keyword phrase or any symbols or input method desired; the keyword can be displayed or featured in any of many possible locations and ways including but not limited to business cards, brochures, magazines, TV commercials, TV shows, radio commercials or shows, window displays and much more; while not required for it to work; the keyword can be used with or without leading or trailing or in any way incorporated special symbols or combinations of special symbols and/or letters (commonly known as hashtags) which can but do not have to be licensed from the server portal owners, when a user sees the keyword they can go and input it in the browser address bar, search for it in search engines, in the form of a link, click on it in a text communication or webpage, and in several other areas and when typing, clicking, tapping, gesturing, or other types of inputting on the resulting keyword or in some way activating it such as but not limited to with voice, gestures, or visual input will take them directly to the associated URL seamlessly without requiring any other input from the user; in the case of the method being used in a software for a computer, network, app, or smart device the mechanism will be the same except that most of the time the keyword will lead to a specific path rather than a URL but it can also lead to a URL both created by the user or gathered from the keyword server without any other input from the user.

2. A server portal for serving, adding, editing, abandoning, deleting keywords and managing accounts which among other functions not specifically delineate here comprises:
a user interface enabling the user to interact with the server portal;
a module for facilitating a plurality of users to manage keywords within the keyword server;
a module for facilitating a plurality of users to manage keywords, bidding, paying, leasing, and other business functions associating with the sales, trading, and managing of the keywords;
a method for allowing links to be created with the keywords and symbols that will act in all other respects as URL links do now but using the keywords which allows for easier input in text messages, chats, and many other areas and allows for devices to input with more than text or voice input as described in claim 1,
a method for achieving the same principles for paths and macros inside, but not limited to, networks, computers, smart devices, and apps for facilitating a plurality of user to manage keywords within the device(s) and in all other respects has the same function as the keyword server but is located in a device and primarily serves paths rather than URLs but it can easily serve URL both user generated and gathered from the keyword server itself thereof,
a third party or the server portal owner browser plug-in or extension that can accomplish the same method as if coded directly into the browser code and would work in the same fashion as described herein;
a third party or the keyword server portal owner itself creating an app for smart devices to provide the same services as the other mechanisms.

3. As example of other possible uses, and the reason which originally lead to the development of this invention, but not limited to this single example: Special hashtag symbols and/or no hashtag at all may be used as a novel pluralities of global worldwide and universally unique user IDs which can be as long as desired. This unique ID will be equivalent in nature to a social security ID number (as used in the USA) for the internet in identifying the user uniquely worldwide and universally as a netizen, regardless of country affiliation, without the need to have a company domain (i.e: http://about.me/reytamayo or http://linkedin.com/reytamayo, etc.) as part of the unique identifier so that the user only uses their name or whatever handle they like as their unique portal ID (equivalent to URL). Using this unique ID a user is not identified through another company such as Facebook, Linkedin, Google Plus, Twitter, About.me, and any number of other social networks or identity website which offer unique profile pages for their users, instead the user's own unique ID (i.e: @Rey Tamayo, $Phatinnovator, &Just Have it Done, Bill Clinton, etc.) is all that needs to be used to identify them without any other branding or complex URL needed. This one of many other possible examples are made possible only by this novel navigation methods which itself is a perfect advertisement tool as well.
